(19) United States
(12) Patent Application Publication
(10) Pub. No.: US 2011/0070497 A1
(43) Pub. Date: Mar. 24, 2011

(54) METHOD OF PRODUCING POSITIVE ELECTRODE FOR LITHIUM ION BATTERY, POSITIVE ELECTRODE FOR LITHIUM ION BATTERY, AND LITHIUM ION BATTERY USING THE POSITIVE ELECTRODE

(76) Inventor: Masaki Deguchi, Hyogo (JP)

(21) Appl. No.: 12/993,613

(22) PCT Filed: Mar. 17, 2010
(86) PCT No.: PCT/JP2010/001903

§ 371 Date: Nov. 19, 2010

(30) Foreign Application Priority Data
Mar. 31, 2009 (JP) 2009-084158

(51) Int. Cl. H01M 4/485; H01M 4/505; H01M 4/525; H01M 4/26

(52) U.S. Cl. 429/223; 429/231.1; 252/182.1

(57) ABSTRACT

A positive electrode for a lithium ion battery having a positive electrode active material layer including a lithium transition metal oxide such as a lithium nickel oxide as a positive electrode active material is washed with a washing fluid containing: an aprotic solvent such as propylene carbonate; and at least one of a fluorine-containing lithium salt such as LiPF₆ and a hydrogen halide such as hydrogen fluoride. By washing the positive electrode with the washing fluid, a lithium halide is attached on a surface of the positive electrode active material in an amount of 300 to 4000 μg per 1 g of the positive electrode active material.

### TECHNICAL FIELD

The present invention relates to lithium ion batteries, and specifically relates to an improvement to a method for removing impurities from a positive electrode active material for lithium ion batteries.

### BACKGROUND ART

Positive electrodes for lithium ion batteries include a lithium transition metal oxide or the like as a positive electrode active material. LiCoO₂ has been commonly used as the lithium transition metal oxide, and in recent years, the use of lithium nickel oxides such as LiNiO₂ is also proposed. Patent Literature 1 discloses a lithium nickel oxide represented by LiₐM_{b}Ni_{c}Co_{d}O₂, where M is at least one metal selected from Al, Mn, Cu, Fe, and the like, and b+c+d=1.

A lithium transition metal oxide is generally synthesized by baking a compound containing a transition metal and a lithium compound. During the synthesis of a lithium transition metal oxide, lithium hydroxide and lithium carbonate are produced as by-products. The lithium hydroxide reacts with a non-aqueous solvent such as ethylene carbonate, to generate gas. The lithium carbonate is decomposed by oxidation in a high temperature environment, to generate gas. For this reason, if the by-products enter the interior of a battery, the battery may swell or the electrode may be deformed due to the generated gas. The swelling of the battery or the deformation of the battery is a factor of causing a deterioration in the cycle characteristics and storage characteristics, as well as a factor of causing a breakage of the battery and an electrolyte leakage.

Patent Literatures 2 to 4 disclose a method for synthesizing a lithium transition metal oxide such as a lithium nickel oxide, the method including baking raw materials followed by washing with water.

### [Citation List]

### [Patent Literature]

[PTL 1] Japanese Laid-Open Patent Publication No. H5-242891
[PTL 2] Japanese Laid-Open Patent Publication No. 2003-17054
[PTL 3] Japanese Laid-Open Patent Publication No. H6-342657
[PTL 4] Japanese Laid-Open Patent Publication No. H10-270025

### SUMMARY OF INVENTION

### Technical Problem

In washing the lithium transition metal oxide with water as disclosed in Patent Literatures 2 to 4, an exchange reaction to exchange Li⁺ ions for H⁺ ions occurs between the lithium transition metal oxide and the water. This exchange reaction also occurs between the lithium transition metal oxide and the residual water in the lithium transition metal oxide having been washed with water. This exchange reaction is particularly noticeable when the lithium transition metal oxide is a lithium nickel oxide containing Ni as a transition metal.

The Li⁺ ions leached out into the water cause lithium hydroxide to be newly deposited on the surface of the lithium transition metal oxide. When the newly deposited lithium hydroxide reacts with carbon dioxide in air, lithium carbonate is produced. As such, washing the lithium transition metal oxide with water is not sufficient for removing lithium hydroxide and lithium carbonate from the lithium transition metal oxide.

### Solution to Problem

A method of producing a positive electrode for a lithium ion battery according to one aspect of the present invention includes the step of washing with a washing fluid, a positive electrode having a positive electrode active material layer including a lithium transition metal oxide as a positive electrode active material, to attach a lithium halide on a surface of the positive electrode active material in an amount of 300 to 4000 μg per 1 g of the positive electrode active material, wherein: the washing fluid includes an aprotic solvent and a solute; and the solute includes at least one of a hydrogen halide and a fluorine-containing lithium salt represented by the general formula (1): LiZF₆₋ₘRₘ₋ₙ, where Z is at least one of phosphorus, boron, arsenic, and antimony; R is a C1 or C2 perfluoroalkyl group; m is an integer of 0 to 3 when Z is phosphorus, 2 when Z is boron, and 0 when Z is arsenic or antimony; and n is 0 when Z is phosphorus, arsenic, or antimony, and 2 when Z is boron.

A positive electrode for a lithium ion battery according to another aspect of the present invention includes a positive electrode current collector, and a positive electrode active material layer formed on a surface of the positive electrode current collector, wherein the positive electrode active material layer includes a lithium transition metal oxide as a positive electrode active material, and a lithium halide is attached on a surface of the positive electrode active material in an amount of 300 to 4000 μg per 1 g of the positive electrode active material.

A lithium ion battery according to yet another aspect of the present invention includes the above-described positive electrode for a lithium ion battery, a negative electrode, a separator interposed between the positive electrode and the negative electrode, and a non-aqueous electrolyte.

### Advantageous Effects of Invention

According to one aspect of the present invention, it is possible to provide a positive electrode for a lithium ion battery, the positive electrode which includes a lithium transition metal oxide as a positive electrode active material and from which lithium hydroxide and lithium carbonate have been highly removed. According to another aspect of the present invention, it is possible to provide a lithium ion battery being configured such that the entrance of lithium hydroxide and lithium carbonate is highly suppressed and being excellent in cycle characteristics, storage characteristics, and reliability.

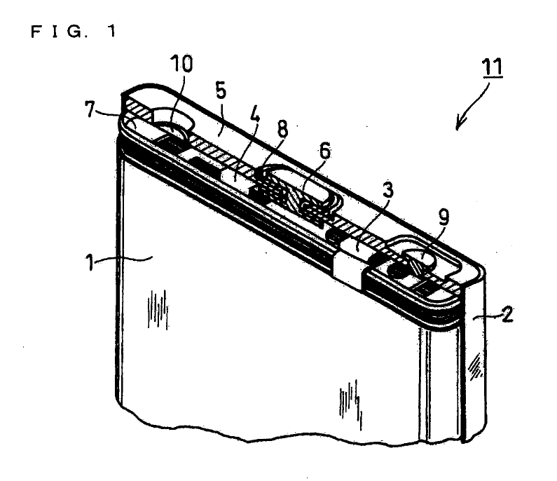

### BRIEF DESCRIPTION OF DRAWING

[FIG. 1] A partially cut-out perspective view showing one embodiment of the lithium ion battery.

### DESCRIPTION OF EMBODIMENT

Various objects, features, aspects and advantages of the present invention will be apparent from the detailed description given hereinafter and the attached drawing.

First, a production method of a positive electrode for a lithium ion battery of the present invention is described.

The production method of a positive electrode for a lithium ion battery includes the step of washing with a washing fluid, a positive electrode having a positive electrode active material layer including a lithium transition metal oxide as a positive electrode active material, to attach a lithium halide on a surface of the positive electrode active material in an amount of 300 to 4000 μg of per 1 g of the positive electrode active material.

The washing fluid for washing the positive electrode includes an aprotic solvent and a solute. The solute includes at least one selected from a fluorine-containing lithium salt represented by the foregoing general formula (1) and a hydrogen halide.

Examples of the fluorine-containing lithium salt represented by the general formula (1) includes LiPF₆, LiBF₄, LiSbF₆, LiAsF₆, LiPF₃(CF₃)₃, LiPF₃(C₂F₅)₃, LiPF₄(CF₃)₂, and LiPF₅CF₃. These fluorine-containing lithium salts may be used singly or in combination of two or more. A particularly preferred lithium salt as the above fluorine-containing lithium salt is LiPF₆.

Examples of the hydrogen halide include hydrogen fluoride, hydrogen chloride, hydrogen bromide, and hydrogen iodide. These hydrogen halides may be used singly or in combination of two or more. A particularly preferred hydrogen halide is hydrogen fluoride.

The fluorine-containing lithium salt represented by the general formula (1) is highly susceptible to hydrolysis. Because of this, when the washing fluid includes the fluorine-containing lithium salt represented by the general formula (1), the fluorine-containing lithium salt is hydrolyzed by the water attached on the surface of the positive electrode active material, to produce hydrogen fluoride. The produced hydrogen fluoride reacts with the lithium hydroxide and lithium carbonate attached on the surface of the positive electrode active material, to produce lithium fluoride.

When the washing fluid includes a hydrogen halide, the hydrogen halide reacts with lithium hydroxide and lithium carbonate, to produce a lithium halide. Examples of the lithium halide to be produced by washing include lithium fluoride, lithium chloride, lithium bromide, and lithium iodide. Among these lithium halides, lithium fluoride is the most inactive and stable. For this reason, the washing fluid particularly preferably includes hydrogen fluoride as the hydrogen halide.

As described above, by washing the positive electrode active material with the above-described washing fluid, the lithium hydroxide and lithium carbonate attached on the surface of the positive electrode active material can be converted into a lithium halide such as lithium fluoride. The lithium halide is dotted on the surface of the positive electrode active material. The lithium halide is a compound which is inactive with respect to the solvent in a non-aqueous electrolyte and is stable (hardly gasified). As such, by converting the lithium hydroxide and lithium carbonate attached on the surface of the positive electrode active material into a lithium halide to make them inactive, the side reaction between the positive electrode active material and the non-aqueous electrolyte can be inhibited.

Examples of the aprotic solvent to be used in the washing fluid include carbonic acid esters such as propylene carbonate, ethylene carbonate, dimethyl carbonate, diethyl carbonate, and ethyl methyl carbonate; cyclic ethers such as tetrahydrofuran, 1,4-dioxan, and 1,3-dioxolane; N-substituted amides such as N-methylformamide, N-methylacetamide, N-methylpropionamide, N,N-dimethylformamide, N,N-diethylformamide, N,N-dimethylacetamide, N-methyl-2-pyrrolidone (NMP), N-cyclohexyl pyrrolidone, and N-methyl caprolactam; N-substituted ureas such as N,N,N′,N′-tetramethylurea, N,N′-dimethyl imidazolidinone, N,N′-dimethyl ethylene urea, and N,N′-dimethylpropylene urea; sulfoxides such as dimethylsulfoxide and tetramethylenesulfoxide; sulfolanes such as sulfolane and dimethyl sulfolane; and nitriles such as acetonitrile and propionitrile. These aprotic solvents can be used singly or in combination of two or more.

Carbonic acid esters are preferred as the aprotic solvent, and among these, propylene carbonate is more preferred.

In the case where the aprotic solvent includes propylene carbonate, the content of the propylene carbonate in the aprotic solvent is preferably 50 to 100% by mass and more preferably 80 to 100% by mass in view of vapor pressure of the solvent.

In the case where the washing fluid includes the fluorine-containing lithium salt represented by the general formula (1) as the solute, the concentration of the fluorine-containing lithium salt expressed as moles per liter of the washing fluid is preferably 0.5 to 1.5 mol/L and more preferably 0.8 to 1.2 mol/L. When the concentration of the fluorine-containing lithium salt is below the foregoing ranges, there is a possibility that the effect of converting the lithium hydroxide and lithium carbonate attached on the surface of the positive electrode active material into lithium fluoride is reduced. If this happens, the effect of removing the lithium hydroxide and lithium carbonate from the positive electrode is reduced. On the other hand, when the fluorine-containing lithium salt is contained at a concentration over the foregoing ranges, despite the higher concentration, the effect of removing the lithium hydroxide and lithium carbonate from the positive electrode remains the same, and the cost of the washing fluid may increase.

The washing fluid including the fluorine-containing lithium salt represented by the general formula (1) may further include a hydrogen halide. By including a hydrogen halide in the washing fluid in advance, the lithium hydroxide and lithium carbonate attached on the surface of the positive electrode active material can be efficiently converted into a lithium halide. As a result, the lithium hydroxide and lithium carbonate can be more efficiently removed from the positive electrode.

In the case where the washing fluid including the fluorine-containing lithium salt represented by the general formula (1) further includes a hydrogen halide, the concentration of the hydrogen halide may be set as appropriate according to the concentration of the fluorine-containing lithium salt. The concentration of the hydrogen halide is preferably 2000 ppm by mass or less based on the whole washing fluid, and more preferably 300 to 1200 ppm by mass, but is not limited thereto. When the concentration of the hydrogen halide is over the foregoing ranges, there is a possibility that the amount of the hydrogen halide in the washing fluid becomes excessive. If this happens, the hydrogen halide may possibly produce an excessive amount of lithium halide by reacting with Li in the positive electrode active material. An excessive amount of lithium halide attached on the positive electrode active material may result in an increased resistance on the surface of the positive electrode active material.

In the case where the washing fluid contains no solute but contains a hydrogen halide, the concentration of the hydrogen halide is preferably 300 to 4000 ppm by mass based on the whole washing fluid, and more preferably 500 to 1500 ppm by mass. When the concentration of the hydrogen halide is below the foregoing ranges, there is a possibility that the effect of converting the lithium hydroxide and lithium carbonate attached on the surface of the positive electrode active material into a lithium halide is reduced. On the other hand, when the concentration of the hydrogen halide is over the foregoing ranges, there is a possibility that the amount of the hydrogen halide in the washing fluid becomes excessive, causing an excessive amount of lithium halide to attach on the positive electrode active material.

Washing of a positive electrode can be performed by, for example, immersing the positive electrode in the above-described washing fluid. The washing fluid is stirred as needed. The positive electrode immersion time is preferably 0.5 to 2 hours, but is not limited thereto.

The temperature of the washing fluid when washing a positive electrode is preferably 40 to 90° C., and more preferably 60 to 90° C. When the temperature of the washing fluid is below the foregoing ranges, there is a possibility that the solute in the washing fluid is unlikely to react with the water attached on the positive electrode active material, resulting in an insufficient amount of hydrogen halide produced. If this happens, the lithium hydroxide and lithium carbonate attached on the surface of the positive electrode active material is hardly converted into lithium fluoride, resulting in a reduction in the effect of removing the lithium hydroxide and lithium carbonate from the positive electrode. On the other hand, when the temperature of the washing fluid is over the foregoing ranges, there is a possibility that an excessive amount of hydrogen halide is produced in the washing fluid. If this happens, an excessive amount of lithium halide may be attached on the positive electrode active material.

After washing the positive electrode with the washing fluid, the positive electrode is rinsed as needed. Rinsing is performed once, or as needed, repeated several times. By such rinsing, the solute in the washing fluid can be rinsed off from the surface of the positive electrode. In rinsing, for example, an aprotic solvent may be used. Examples of the aprotic solvent used for rinsing are the same as those listed as the aprotic solvent in the washing fluid for washing the positive electrode. In rinsing, the aprotic solvent is used without any solute such as a lithium salt in it.

The aprotic solvent used for rinsing is not particularly limited, but is preferably an aprotic solvent to be used as a below-described non-aqueous solvent for a non-aqueous electrolyte, in view of simplifying a drying step performed subsequently to rinsing.

By performing the above-described washing and further performing the above-described rinsing as needed, with respect to the positive electrode having a positive electrode active material layer including a lithium transition metal oxide as a positive electrode active material, it is possible to convert the lithium hydroxide and lithium carbonate attached on the surface of the positive electrode active material into a lithium halide such as lithium fluoride, so that the amount of the attached lithium halide per 1 g of the positive electrode active material is adjusted to 300 to 4000 μg. Within this range, 700 to 3200 μg per 1 g of the positive electrode active material is preferred, 1100 to 3200 μg is more preferred, and 1800 to 3200 μg is particularly preferred.

When the amount of the attached lithium halide per 1 g of the positive electrode active material exceeds 4000 μg, an excessive amount of lithium halide is attached on the positive electrode active material, which may disadvantageously increase the resistance on the surface of the positive electrode active material.

When the amount of the attached lithium halide per 1 g of the positive electrode active material exceeds 4000 μg, the fluorine-containing lithium salt represented by the general formula (1) and the hydrogen halide are considered to be present in excess in the washing fluid for washing the positive electrode with high probability. This means that the amount of the hydrogen halide such as hydrogen fluoride in the washing fluid greatly exceeds the amount thereof required for converting the lithium hydroxide and lithium carbonate attached on the surface of the positive electrode active material into a lithium halide. Such excessive hydrogen halide facilitates the exchange reaction in which Li⁺ ions in the positive electrode are exchanged for H⁺ ions derived from the hydrogen halide, to newly form a lithium halide on the surface of the positive electrode active material layer. The lithium halide excessively formed on the surface of the positive electrode active material becomes a factor of causing the surface resistance of the positive electrode active material to increase.

On the other hand, when the amount of the attached lithium halide per 1 g of the positive electrode active material is below 300 μg, the conversion of the lithium hydroxide and lithium carbonate attached on the surface of the positive electrode active material into a lithium halide is considered to be insufficient with high probability.

It should be noted that in the case where the positive electrode having a positive electrode active material layer including a lithium transition metal oxide as a positive electrode active material is used without being subjected to the above-described washing with the washing fluid and is brought into contact with non-aqueous electrolyte, to fabricate a lithium ion battery, even if charge/discharge is performed thereafter, the amount of the lithium fluoride attached on the surface of the positive electrode active material is a few μg or less per 1 g of the positive electrode active material or below the detection limit.

The amount of the lithium halide on the surface of the positive electrode active material layer can be determined, for example, by utilizing the property of lithium halides of being capable of dissolving in water. Specifically, first, the positive electrode is immersed in water, to dissolve the lithium halide attached on the surface of the positive electrode active material in water. The temperature of the water in which the positive electrode is immersed is preferably 15 to 25° C., and the time during which the positive electrode is immersed in water is preferably 10 minutes to 1 hour. Subsequently, the amount of the halide ions in the water in which the lithium halide is dissolved is determined by a method such as ion chromatography. Consequently, the amount of the lithium halide per 1 g of the positive electrode active material can be calculated.

According to the above-described production method of a positive electrode for a lithium ion battery, the entrance of lithium hydroxide and lithium carbonate in the positive electrode and in the interior of the battery can be highly suppressed. As such, by using the positive electrode obtained by the above-described production method in a lithium ion battery, the effect of reducing the generation of gas during operation of the battery can be further enhanced. As a result, the cycle characteristics, storage characteristics, and reliability of the lithium ion battery can be improved, and in particular, the effect of reducing the generation of gas in a high temperature environment can be enhanced.

Next, the positive electrode for a lithium ion battery of the present invention is described.

The positive electrode for a lithium ion battery includes a positive electrode current collector, and a positive electrode active material layer being formed on a surface of the positive electrode current collector and including a lithium transition metal oxide.

The positive electrode current collector may be any current collector used in the positive electrode for a lithium ion battery without any particular limitation. For example, a current collector made of aluminum, aluminum alloy or the like may be used. The thickness of the positive electrode current collector is not particularly limited, but is preferably 5 to 100 μm.

The positive electrode active material forming the positive electrode active material layer includes a lithium transition metal oxide. Examples of the lithium transition metal oxide include various lithium transition metal oxides used as a positive electrode active material for lithium ion batteries. Among these, lithium nickel oxides are preferred.

A preferred lithium nickel oxide is a compound represented by the general formula (2): LiₓNi_{w}M_{z}Me_{1-(w+z)}O_{2+d}, where M is at least one element selected from cobalt and manganese; Me is at least one element selected from metal elements other than M, boron, phosphorus, and sulfur; d represents oxygen deficiency or oxygen surplus; 0.98≦x≦1; 0.3≦w≦1; 0≦z≦0.7; and 0.9≦(w+z)≦1.

Another positive electrode active material other than the lithium transition metal oxide may be used as the positive electrode active material. Any positive electrode active material used for lithium ion batteries may be used without any particular limitation as the another positive electrode active material.

In the lithium nickel oxide represented by the general formula (1), the ratio of Li atoms represented by x changes during charging and discharging. For this reason, the value of x is not particularly limited, but is generally 0.98 or more and 1 or less, and preferably 0.98 or more and 0.99 or less.

The ratio of Ni atoms represented by w is 0.3 or more and 1.0 or less, preferably 0.7 or more and 0.95 or less, and more preferably 0.75 or more and 0.9 or less. When w is below 0.3, the effect of Ni in the lithium transition metal oxide to further improve the capacity of the lithium transition metal oxide is not sufficiently obtained.

M represents either cobalt (Co) or manganese (Mn), or alternatively both Co and Mn. The ratio of M atoms represented by z is 0 or more and 0.7 or less, and preferably 0.05 or more and 0.25 or less.

Me represents at least one element selected from the group consisting of metal elements other than M, boron (B), phosphorus (P), and sulfur (S). Examples of the metal elements other than M include Al, Cr, Fe, Mg, and Zn, and Al is particularly preferred. Me contains one element or two or more elements selected from the above-listed other metal elements, B, P, and S. The ratio of Me atoms represented by 1−(w+z) is 0 or more and 0.1 or less, and preferably 0 or more and 0.05 or less.

The oxygen deficiency or oxygen surplus represented by d is usually within ±1% of the stoichiometric ratio of oxygen, and preferably within ±0.5%. Specifically, −0.02≦d≦0.02, and preferably −0.01≦d≦0.01.

Examples of the lithium nickel oxide include LiNi_{w}Co_{z}Al_{1-(w+z)}O_{2+δ}, and LiNi_{w}Co_{z′}Mn_{z″}O_{2+δ}, where z′+z″=z, but are not limited thereto.

The lithium transition metal oxide can be produced by a known method. In one exemplary method, a compound containing nickel (Ni), element M, and element Me is baked together with a lithium compound, and washed with a below-described washing fluid.

The compound containing Ni, element M, and element Me may be in the form of, for example, an hydroxide, an oxide, a carbonate, or an oxalate. Such a compound is commercially available, or can be synthesized by a known method.

Examples of the lithium compound include lithium hydroxide, lithium carbonate, lithium nitrate, and lithium peroxide, and in particular, lithium hydroxide or lithium carbonate is preferred. The lithium compound is commercially available, or can be synthesized by a known method.

The conditions for baking the compound containing Ni, element M, element Me together with the lithium compound are not particularly limited, and known baking conditions may be employed. The baking temperature is preferably 650 to 900° C. The lithium transition metal oxide may also be synthesized by multistage baking. The atmosphere during baking may be, for example, an air atmosphere or an oxygen atmosphere. The partial pressure of oxygen in the atmosphere during baking is preferably increased with increasing the content of nickel in the lithium transition metal oxide to be produced. The atmosphere during baking preferably contains substantially no carbon dioxide. Further, the dew point of the atmosphere during baking is preferably −20° C. or lower.

On the surface of the lithium transition metal oxide synthesized by baking, lithium hydroxide and lithium carbonate are attached. This is because the lithium transition metal oxide synthesized by baking adsorbs water, for example, when cools. The water adsorbed onto the lithium transition metal oxide reacts with the lithium in the lithium transition metal oxide to cause an exchange reaction to exchange Li⁺ ions for H⁺ ions, to produce lithium hydroxide. The lithium hydroxide reacts with air to produce lithium carbonate.

After a positive electrode is produced, the lithium hydroxide and lithium carbonate attached on the surface of the lithium transition metal oxide are converted into a lithium halide by washing the positive electrode with the above-described washing fluid. The lithium hydroxide and lithium carbonate can thus be removed from the surface of the lithium transition metal oxide.

The positive electrode active material layer in the above positive electrode for a lithium ion battery can be obtained, for example, by applying a paste for forming a positive electrode active material layer on a surface of a positive electrode current collector, and drying the paste, the paste including a lithium transition metal oxide serving as a positive electrode active material, a binder, a dispersion medium, and, as needed, a conductive agent and the like.

Examples of the dispersion medium include NMP, acetone, methyl ethyl ketone, tetrahydrofuran, dimethylformamide, dimethylacetamide, and tetramethylurea, trimethylphosphate.

Examples of the binder include known various binders such as polyvinylidene fluoride, polytetrafluoroethylene, styrene-butadiene rubber, and carboxymethyl cellulose.

Examples of the conductive agent include graphites; carbon blacks such as acetylene black, Ketjen black, channel black, furnace black, lamp black, and thermal black; carbon fibers; and various metal fibers.

The content of the positive electrode active material in the positive electrode active material layer is preferably 70 to 98 parts by mass per 100 parts by mass of the total amount of the positive electrode active material, the binder, and the additive such as the conductive agent (the amount obtained by subtracting the amount of the dispersion medium from the total amount of the paste for forming a positive electrode active material layer), and more preferably about 85 parts by weight.

Next, the lithium ion battery of the present invention is described.

FIG. 1 is a partially cut-out perspective view schematically showing the configuration of a lithium ion battery according to one embodiment of the present invention. A lithium ion battery 11 of FIG. 1 includes an electrode assembly 1 formed by winding the above-described positive electrode for a lithium ion battery, a negative electrode, and a separator interposed between the positive electrode and the negative electrode; and a non-aqueous electrolyte (not shown).

The electrode assembly 1 is encased in a battery case 2 together with a non-aqueous electrolyte (not shown), and the battery case 2 is sealed with a sealing plate 5. The electrode assembly 1 is provided with, at one end thereof in the winding axis direction, a positive electrode lead 3 connected to the positive electrode and a negative electrode lead 4 connected to the negative electrode. The positive electrode lead 3 is connected to the sealing plate 5 in the opening end side of the battery case 2. The sealing plate 5 serves as a positive electrode terminal. The negative electrode lead 4 is connected to a negative electrode terminal 6 in the opening end side of the battery case 2. An insulating plate 7 disposed inside the battery case 2 provides insulation between the electrode assembly 1 and the sealing plate 5, and further provides insulation between the positive electrode lead 3 and the negative electrode lead 4. The negative electrode terminal 6 is disposed in a through hole provided in the sealing plate 5, and the sealing plate 5 and the negative electrode terminal 6 are insulated from each other by an insulating packing 8 disposed around the through hole. The sealing plate 5 is further provided with an injection port for non-aqueous electrolyte, a cap 9 for closing the injection port, and a battery safety valve 10.

The negative electrode has a negative electrode current collector and a negative electrode active material layer formed on the negative electrode current collector.

As the negative electrode current collector, various current collectors used for negative electrodes for lithium ion batteries may be used. For example, thin films made of metals, such as stainless steel, nickel, copper, and titanium; carbon, conductive resins, and the like may be used without any particular limitation. These negative electrode current collectors may be surface-treated with carbon, nickel, titanium or the like. The thickness of the negative electrode current collector is not particularly limited, but is generally 5 to 100 μm.

The negative electrode active material layer includes a negative electrode active material, and further includes a conductive agent and a binder as needed.

As the negative electrode active material, various negative electrode active materials used for lithium ion batteries may be used. For example, carbon materials such as graphite and amorphous carbon; simple substance of silicon or tin; alloys or solid solutions containing silicon or thin; and composite materials of these may be used without any particular limitation.

Examples of the conductive agent and the binder are the same as those listed as the conductive agent and the binder used for the positive electrode.

Examples of the separator include microporous thin films, woven fabrics, and non-woven fabrics having a high ion permeability, a predetermined mechanical strength, and an insulating property. Among these, a microporous film made of polyolefin such as polypropylene and polyethylene is preferred because of its excellent durability and shutdown function, in view of improving the reliability of lithium ion batteries. The thickness of the separator is generally 10 μm or more and 300 μm or less, and preferably 10 μm or more and 40 μm or less.

The non-aqueous electrolyte includes, for example, a lithium salt serving as a solute, and a non-aqueous solvent.

The non-aqueous solvent may be an aprotic organic solvent, examples of which include carbonic acid esters such as ethylene carbonate, propylene carbonate, dimethyl carbonate, and ethyl methyl carbonate; ethers such as tetrahydrofuran and 1,3-dioxolane; carboxylic acid esters such as γ-butyrolactone. These non-aqueous solvents may used singly or in combination of two or more.

Examples of the lithium salt include the fluorine-containing lithium salts as used for the washing fluid for the positive electrode for a lithium ion battery, and other than these, various solutes used for non-aqueous electrolyte. Preferred examples among these include LiPF₆ and LiBF₄. These lithium salts may be used singly or in combination of two or more.

According to the lithium ion battery configured as described above, the remaining amount of lithium hydroxide and lithium carbonate in the positive electrode is significantly reduced, and therefore, the entrance of these lithium hydroxide and lithium carbonate in the interior of the battery is highly suppressed. As such, by configuring as described above, a lithium ion battery excellent in cycle characteristics, storage characteristics, reliability and the like can be provided.

An example applied to a lithium ion battery of wound type and prismatic shape is given in the above description, but the shape and type of the lithium ion battery is not limited thereto. The shape and type of the lithium ion battery may be selected appropriately according to the application of the lithium ion battery, from various shapes and types such as a coin shape, a cylindrical shape, a sheet shape, a button shape, a flat type and a laminate type. The present invention is not limited to a lithium ion battery for small devices, but is also effective as a lithium ion battery for large-sized high capacity devices such as a power source for electric vehicles and a power source for power storage.

### EXAMPLES

### Example 1

(1) Production and Washing of Positive Electrode

First, 1 g of LiNi_{0.80}Co_{0.15}Al_{0.05}O₂ powder, 0.5 kg of an NMP solution of polyvinylidene fluoride (#1320 available from KUREHA CORPORATION, concentration of solid matter 12 mass %), and 40 g of acetylene black were placed together with an appropriate amount of NMP in a double-arm kneader, and stirred at 30° C. for 30 minutes, to prepare a paste for forming a positive electrode active material layer. The prepared paste was applied onto both surfaces of a 20-μm-thick aluminum foil serving as a positive electrode current collector, and died at 120° C. for 15 minutes to form a positive electrode active material layer. Next, the positive electrode current collector with the positive electrode active material layers formed thereon was roll-pressed to adjust the total thickness of the positive electrode current collector and the positive electrode active material layers to 160 μm, to produce a positive electrode. The produced positive electrode was cut in the size suitable for being encased in a prismatic battery case (height 50 mm, width 34 mm, and thickness 5 mm). A positive electrode lead was connected to a part of the positive electrode.

LiPF₆ was dissolved in an amount of 15.2 g in 100 mL of propylene carbonate, to prepare a washing fluid for positive electrode (LiPF₆/PC) in which the concentration of LiPF₆ was 1.0 mol/L. The above-obtained positive electrode was wound and inserted into a beaker of 50 mL capacity, and into this beaker, about 50 mL of the washing fluid for positive electrode (LiPF₆/PC) was poured. With the whole positive electrode kept immersed in the washing fluid for positive electrode, the beaker was placed in a constant-temperature bath and was allowed to stand at 20° C. for 1 hour, thereby to wash the positive electrode (washing).

The positive electrode having been washed was wound and inserted into a beaker of 50 mL capacity, and into this beaker, about 50 mL of propylene carbonate was poured. With the whole positive electrode kept immersed in the propylene carbonate, the beaker was allowed to stand for 5 minutes while being stirred slightly, and then the propylene carbonate was thrown away (rinsing). The rinsing was repeated three times totally, to rinse off LiPF₆ from the positive electrode. The positive electrode having been rinsed was vacuum dried at 80° C. and 1 mmHg for 10 minutes, thereby to remove propylene carbonate from the positive electrode.

(2) Production of Negative Electrode

First, 3 kg of artificial graphite, 200 g of dispersion of modified styrene-butadiene rubber (BM-400B available from Zeon Corporation, Japan, solid content 40 mass %), and 50 g of carboxymethyl cellulose were placed together with an appropriate amount of water in a double-arm kneader, and stirred, to prepare a paste for forming a negative electrode active material layer. The prepared paste for forming a negative electrode active material layer was applied onto both surfaces of a 12-μm-thick copper foil serving as a negative electrode current collector, and died at 120° C. to form negative electrode active material layers. Next, the negative electrode current collector with the negative electrode active material layers formed thereon was roll-pressed to adjust the total thickness of the negative electrode current collector and the negative electrode active material layers to 160 μm, to produce a negative electrode. The produced negative electrode was cut in the size suitable for being encased in the foregoing prismatic battery case. A negative electrode lead was connected to a part of the negative electrode.

(3) Preparation of Non-Aqueous Electrolyte

Ethylene carbonate, propylene carbonate, and diethyl carbonate were mixed in a ratio of 3:3:4 by volume. In the non-aqueous solvent thus prepared, LiPF₆ and vinylene carbonate were dissolved, to prepare a non-aqueous electrolyte. The concentration of LiPF₆ in the non-aqueous electrolyte was 1.0 mol/L, and the concentration of vinylene carbonate was 5% by mass.

(4) Fabrication of Lithium Ion Battery

The positive electrode having been subjected to the above-described washing process, the above-obtained negative electrode, the above-obtained non-aqueous electrolyte, and a polyethylene-polypropylene composite film (product number “2300” available from Celgard K.K., thickness 25 μm) serving as a separator were used to fabricate a prismatic lithium ion battery (design capacity 900 mAh) as shown in FIG. 1.

(5) Physical Property Evaluation of Lithium Ion Battery

(i) Measurement of Capacity Retention Rate and Battery Swelling Amount

The above-obtained lithium ion battery was subjected charge/discharge cycles repeated at 45° C. under the conditions below. Assuming that the discharge capacity at the 3rd cycle was 100%, the discharge capacity after 500 cycles was expressed as a percentage, which was defined as the capacity retention rate (%). The thicknesses of the center portion of the largest plane (length 50 mm, width 34 mm) of the prismatic battery at the end of the charge in the 3rd cycle and at the end of the charge in the 501th cycle were measured, to determine the amount of battery swelling (mm) due to repeated charge/discharge cycles at 45° C. The result is shown in Table 1 below.

Charge/discharge conditions for charge/discharge cycles:

In the charge, a constant current-constant voltage charge was performed for 2.5 hours with the maximum current being set at 630 mA and the upper limit voltage being set at 4.2 V. The battery was allowed to stand after charge for 10 minutes. In the discharge, a constant current discharge was performed at a discharge current of 900 mA with the discharge cut-off voltage being set at 2.5 V. The battery was allowed to stand after discharge for 10 minutes.

(ii) Determination of Amount of Lithium Fluoride Attached on Positive Electrode Surface

The above-obtained lithium ion battery was subjected to three charge/discharge cycles at 25° C. under the conditions above. The battery at the end of the discharge in the 3rd cycle was disassembled to take out the positive electrode therefrom. A piece of the positive electrode of 2.0 cm in length and 2.0 cm in width was cut out from the center portion thereof. The positive electrode piece thus obtained was immersed in ethyl methyl carbonate and washed. This procedure of immersion and washing was repeated three times in total, thereby to remove the non-aqueous electrolyte and the like from the positive electrode piece.

Subsequently, the positive electrode piece and 25 mL of ion-exchange water were placed in a 50 mL sample bottle, such that the positive electrode piece was immersed in the ion-exchange water. With the whole positive electrode piece kept immersed in the ion-exchange water, the ion-exchange water was stirred for 30 minutes. Within 10 minutes upon stirring, the ion-exchange water in the sample bottle was filtrated through a 0.45-μm mesh filter. The filtrate obtained by filtration was used as a measurement sample. The amount (μg) of the fluoride ions contained in the measurement sample was determined by ion chromatography, to determine the amount of the attached lithium fluoride (μg/g) per 1 g mass of the positive electrode active material. The measurement results are shown in Table 2 below.

In this Example, the positive electrode piece having been subjected to three charge/discharge cycles was used as a sample for measuring the amount of the attached lithium fluoride. It should be noted that no significant difference was observed between the amounts of the attached lithium fluoride determined immediately after the positive electrode produced in the above was washed with the washing fluid, and determined after the positive electrode having been subjected to washing was used to fabricate a battery and the battery was subjected to charge/discharge cycles repeated several times.

### Examples 2 to 8

Lithium ion batteries were fabricated in the same manner as in Example 1, except that the temperatures in washing the positive electrode were set to the values shown in Table 1 below. The physical properties of the batteries thus fabricated were evaluated in the same manner as in Example 1.

### Comparative Example 1

A lithium ion battery was fabricated in the same manner as in Example 1, except that the positive electrode was not washed. The physical properties of the battery thus fabricated were evaluated in the same manner as in Example 1.

### Examples 9 to 16

In 100 mL of PC, 15.2 g of LiPF₆ was dissolved, and hydrogen fluoride (HF) was further added, to prepare a washing fluid for positive electrode. The concentration of LiPF₆ in the prepared washing fluid (LiPF₆+HF/PC) was 1.0 mol/L, and the concentration of HF was 400 ppm. Lithium ion batteries were fabricated in the same manner as in Examples 1 to 8, except that the washing fluid for positive electrode (LiPF₆+HF/PC) was used in place of LiPF₆/PC. The physical properties of the lithium ion batteries thus fabricated were evaluated in the same manner as in Example 1. The results are shown in Table 2 below.

### Examples 17 to 24

HF was added to PC, to prepare a washing fluid for positive electrode. In the prepared washing fluid (HF/PC), the content of HF was 400 ppm relative to the total mass of the washing fluid for positive electrode. Lithium ion batteries were fabricated in the same manner as in Examples 1 to 8, except that the washing fluid for positive electrode (HF/PC) was used in place of LiPF₆/PC. The physical properties of the lithium ion batteries thus fabricated were evaluated in the same manner as in Example 1. The results are shown in Table 3 below.

### Examples 25 to 32

HF was added to PC, to prepare a washing fluid for positive electrode. In the prepared washing fluid (HF/PC). The content of HF was 2000 ppm relative to the total mass of the washing fluid for positive electrode. Lithium ion batteries were fabricated in the same manner as in Examples 1 to 8, except that the washing fluid for positive electrode (HF/PC) was used in place of LiPF₆/PC. The physical properties of the lithium ion batteries thus fabricated were evaluated in the same manner as in Example 1. The results are shown in Table 4 below.

The measurement results of the capacity retention rate, battery swelling, and amount of the attached LiF were judged in four grades: A+ (extremely good), A (good), B (acceptable), and C (no good).

TABLE 1
Positive electrode active material: LiNi_{0.80}Co_{0.15}Al_{0.05}O₂
Washing fluid: LiPF₆/PC (LiPF₆ concentration: 1 mol/L)

| | | Capacity | | | | Amount of | |
|---|---|---|---|---|---|---|---|
| | Washing | retention | | Battery | | attached | |
| | temper- | rate | | swelling | | LiF | |
| | ature | [%] | | [mm] | | [μg/g] | |
| Ex. 1 | 20° C. | 80.3 | A | 0.58 | B | 350 | B |
| Ex. 2 | 30° C. | 81.9 | A | 0.49 | A | 650 | A |
| Ex. 3 | 40° C. | 85.5 | A+ | 0.34 | A+ | 1870 | A+ |
| Ex. 4 | 60° C. | 87.0 | A+ | 0.30 | A+ | 2340 | A+ |
| Ex. 5 | 80° C. | 89.2 | A+ | 0.25 | A+ | 2750 | A+ |
| Ex. 6 | 90° C. | 85.2 | A+ | 0.35 | A+ | 2980 | A+ |
| Ex. 7 | 100° C. | 84.4 | A+ | 0.47 | A | 3160 | A+ |
| Ex. 8 | 110° C. | 81.3 | A | 0.52 | B | 3300 | A |
| Com. | not | 54.2 | C | 1.05 | C | 210 | C |

| | |
|---|---|
| Ex. 1 | washed |

TABLE 2
Positive electrode active material: LiNi_{0.80}Co_{0.15}Al_{0.05}O₂
Washing fluid: LiPF₆ + HF/PC
(LiPF₆ concentration: 1 mol/L, HF concentration: 400 ppm)

| | | | | | | Amount of | |
|---|---|---|---|---|---|---|---|
| | Washing | Capacity | | Battery | | attached | |
| | temper- | retention | | swelling | | LiF | |
| | ature | rate [%] | | [mm] | | [μg/g] | |
| Ex. 9 | 20° C. | 83.0 | A | 0.45 | A | 730 | A |
| Ex. 10 | 30° C. | 83.8 | A | 0.43 | A | 1030 | A |
| Ex. 11 | 40° C. | 86.7 | A+ | 0.32 | A+ | 2270 | A+ |
| Ex. 12 | 60° C. | 89.0 | A+ | 0.26 | A+ | 2760 | A+ |
| Ex. 13 | 80° C. | 86.1 | A+ | 0.29 | A+ | 3070 | A+ |
| Ex. 14 | 90° C. | 84.6 | A+ | 0.48 | A | 3250 | A |
| Ex. 15 | 100° C. | 80.9 | A | 0.56 | B | 3460 | A |
| Ex. 16 | 110° C. | 80.1 | A | 0.59 | B | 3570 | A |

TABLE 3
Positive electrode active material: LiNi_{0.80}Co_{0.15}Al_{0.05}O₂
Washing fluid: HF/PC (HF concentration: 400 ppm)

| | | | | | | Amount of | |
|---|---|---|---|---|---|---|---|
| | Washing | Capacity | | Battery | | attached | |
| | temper- | retention | | swelling | | LiF | |
| | ature | rate [%] | | [mm] | | [μg/g] | |
| Ex. 17 | 20° C. | 80.5 | A | 0.58 | B | 320 | B |
| Ex. 18 | 30° C. | 80.7 | A | 0.58 | B | 330 | B |
| Ex. 19 | 40° C. | 80.5 | A | 0.56 | B | 330 | A |
| Ex. 20 | 60° C. | 80.6 | A | 0.56 | B | 350 | A |
| Ex. 21 | 80° C. | 80.8 | A | 0.57 | B | 380 | B |
| Ex. 22 | 90° C. | 80.3 | A | 0.57 | B | 380 | B |
| Ex. 23 | 100° C. | 80.2 | A | 0.58 | B | 390 | B |
| Ex. 24 | 110° C. | 80.4 | A | 0.56 | B | 390 | B |

TABLE 4
Positive electrode active material: LiNi_{0.80}Co_{0.15}Al_{0.05}O₂
Washing fluid: HF/PC (HF concentration: 2000 ppm)

| | Washing | Capacity | | Battery | | Amount of | |
|---|---|---|---|---|---|---|---|
| | temper- | retention | | swelling | | attached | |
| | ature | rate [%] | | [mm] | | LiF [μg/g] | |
| Ex. 25 | 20° C. | 84.4 | A+ | 0.49 | A | 1810 | A+ |
| Ex. 26 | 30° C. | 84.7 | A+ | 0.47 | A | 1830 | A+ |
| Ex. 27 | 40° C. | 85.0 | A+ | 0.41 | A+ | 1870 | A+ |
| Ex. 28 | 60° C. | 85.3 | A+ | 0.38 | A+ | 1900 | A+ |
| Ex. 29 | 80° C. | 86.0 | A+ | 0.32 | A+ | 1930 | A+ |
| Ex. 30 | 90° C. | 85.3 | A+ | 0.35 | A+ | 1950 | A+ |
| Ex. 31 | 100° C. | 83.2 | A | 0.50 | A | 1950 | A+ |
| Ex. 32 | 110° C. | 82.4 | A | 0.53 | B | 1960 | A+ |

As evident from Table 1, in Examples 1 to 8 in which the positive electrode was washed with the washing fluid containing LiPF₆ and PC, the capacity retention rate of the lithium ion battery was improved, and the amount of battery swelling after charge/discharge cycling was reduced. In Examples 1 to 8, the amount of the attached lithium fluoride in the battery after fabrication was 300 μg or more and 4000 μg or less per 1 g mass of the positive electrode active material.

As evident from Table 2, in Examples 9 to 16 in which the positive electrode was washed with the washing fluid containing LiPF₆, PC, and HF, the capacity retention rate of the lithium ion battery was high, and the amount of battery swelling after charge/discharge cycling was reduced. In Examples 9 to 16, the amount of the attached lithium fluoride in the battery after fabrication was 700 μg or more and 4000 μg or less per 1 g mass of the positive electrode active material.

As evident from Table 3, in Examples 17 to 24 in which the positive electrode was washed with the washing fluid containing PC and HF, the capacity retention rate of the lithium ion battery was improved, and the amount of battery swelling after charge/discharge cycling was reduced. In Examples 17 to 24, the amount of the attached lithium fluoride in the battery after fabrication was 300 μg or more and 700 μg or less per 1 g mass of the positive electrode active material.

As evident from Table 4, in Examples 25 to 32 in which the positive electrode was washed with the washing fluid containing PC and HF, the capacity retention rate of the lithium ion battery was improved, and the amount of battery swelling after charge/discharge cycling was reduced. In Examples 25 to 32, the amount of the attached lithium fluoride in the battery after fabrication was 1800 μg or more and 3200 μg or less per 1 g mass of the positive electrode active material.

### Examples 33 to 40 and Comparative Example 2

Lithium ion batteries were fabricated in the same manner as in Examples 1 to 8 and Comparative Example 1, except that 1 kg LiNi_{1/3}Mn_{1/3}Co_{1/3}O₂ powder was used as the positive electrode active material in place of 1 kg of LiNi_{0.80}Co_{0.15}Al_{0.05}O₂ powder. The physical properties of the lithium ion batteries thus fabricated were evaluated in the same manner as in Example 1. The results are shown in Table 5 below.

### Examples 41 to 48

Lithium ion batteries were fabricated in the same manner as in Examples 9 to 16, except that 1 kg LiNi_{1/3}Mn_{1/3}Co_{1/3}O₂ powder was used as the positive electrode active material in place of 1 kg of LiNi_{0.80}Co_{0.15}Al_{0.05}O₂ powder. The physical properties of the lithium ion batteries thus fabricated were evaluated in the same manner as in Example 1. The results are shown in Table 6 below.

### Examples 49 to 56

Lithium ion batteries were fabricated in the same manner as in Examples 17 to 24, except that 1 kg LiNi_{1/3}Mn_{1/3}Co_{1/3}O₂ powder was used as the positive electrode active material in place of 1 kg of LiNi_{0.80}Co_{0.15}Al_{0.05}O₂ powder. The physical properties of the lithium ion batteries thus fabricated were evaluated in the same manner as in Example 1. The results are shown in Table 7 below.

### Examples 57 to 64

Lithium ion batteries were fabricated in the same manner as in Examples 25 to 32, except that 1 kg LiNi_{1/3}Mn_{1/3}Co_{1/3}O₂ powder was used as the positive electrode active material in place of 1 kg of LiNi_{0.80}Co_{0.15}Al_{0.05}O₂ powder. The physical properties of the lithium ion batteries thus fabricated were evaluated in the same manner as in Example 1. The results are shown in Table 8 below.

TABLE 5
Positive electrode active material: LiNi_{1/3}Mn_{1/3}Co_{1/3}O₂
Washing fluid: LiPF₆/PC (LiPF₆ concentration: 1 mol/L)

| | Washing | Capacity | | Battery | | Amount of | |
|---|---|---|---|---|---|---|---|
| | temper- | retention | | swelling | | attached | |
| | ature | rate [%] | | [mm] | | LiF [μg/g] | |
| Ex. 33 | 20° C. | 82.5 | A | 0.46 | B | 740 | A |
| Ex. 34 | 30° C. | 84.0 | A+ | 0.38 | A+ | 1130 | A+ |
| Ex. 35 | 40° C. | 87.2 | A+ | 0.29 | A+ | 2010 | A+ |
| Ex. 36 | 60° C. | 89.1 | A+ | 0.27 | A+ | 2460 | A+ |
| Ex. 37 | 80° C. | 89.8 | A+ | 0.21 | A+ | 2900 | A+ |
| Ex. 38 | 90° C. | 87.3 | A+ | 0.24 | A+ | 3090 | A+ |
| Ex. 39 | 100° C. | 85.8 | A+ | 0.35 | A+ | 3280 | A+ |
| Ex. 40 | 110° C. | 82.7 | A | 0.44 | A | 3420 | A |
| Com. | Not | 54.9 | C | 1.01 | C | 210 | C |

| | |
|---|---|
| Ex. 2 | washed |

TABLE 6
Positive electrode active material: LiNi_{1/3}Mn_{1/3}Co_{1/3}O₂
Washing fluid: LiPF₆ + HF/PC
(LiPF₆ concentration: 1 mol/L, HF concentration: 400 ppm)

| | Washing | Capacity | | Battery | | Amount of | |
|---|---|---|---|---|---|---|---|
| | temper- | retention | | swelling | | attached | |
| | ature | rate [%] | | [mm] | | LiF [μg/g] | |
| Ex. 41 | 20° C. | 84.4 | A+ | 0.37 | A+ | 1120 | A |
| Ex. 42 | 30° C. | 86.8 | A+ | 0.30 | A+ | 1390 | A |
| Ex. 43 | 40° C. | 88.5 | A+ | 0.26 | A+ | 2470 | A+ |
| Ex. 44 | 60° C. | 89.7 | A+ | 0.21 | A+ | 2680 | A+ |
| Ex. 45 | 80° C. | 89.9 | A+ | 0.20 | A+ | 3100 | A+ |
| Ex. 46 | 90° C. | 88.0 | A+ | 0.27 | A+ | 3230 | A |
| Ex. 47 | 100° C. | 84.9 | A+ | 0.38 | A+ | 3410 | A |
| Ex. 48 | 110° C. | 82.1 | A | 0.47 | A | 3650 | A |

TABLE 7
Positive electrode active material: LiNi_{1/3}Mn_{1/3}Co_{1/3}O₂
Washing fluid: HF/PC (HF concentration: 400 ppm)

| | | Capacity | | | | Amount of | |
|---|---|---|---|---|---|---|---|
| | Washing | retention | | Battery | | attached | |
| | temper- | rate | | swelling | | LiF | |
| | ature | [%] | | [mm] | | [μg/g] | |
| Ex. 49 | 20° C. | 82.3 | A | 0.46 | B | 380 | B |
| Ex. 50 | 30° C. | 82.6 | A | 0.47 | B | 380 | B |
| Ex. 51 | 40° C. | 82.4 | A | 0.48 | B | 390 | A |
| Ex. 52 | 60° C. | 82.7 | A | 0.44 | B | 390 | A |
| Ex. 53 | 80° C. | 82.7 | A | 0.47 | B | 390 | B |
| Ex. 54 | 90° C. | 82.1 | A | 0.46 | B | 390 | B |
| Ex. 55 | 100° C. | 82.0 | A | 0.48 | B | 390 | B |
| Ex. 56 | 110° C. | 81.9 | A | 0.49 | B | 390 | B |

TABLE 8
Positive electrode active material: LiNi_{1/3}Mn_{1/3}Co_{1/3}O₂
Washing fluid: HF/PC (HF concentration: 2000 ppm)

| | | Capacity | | | | Amount | |
|---|---|---|---|---|---|---|---|
| | Washing | retention | | Battery | | of attached | |
| | temper- | rate | | swelling | | LiF | |
| | ature | [%] | | [mm] | | [μg/g] | |
| Ex. 57 | 20° C. | 86.1 | A+ | 0.39 | A+ | 1950 | A+ |
| Ex. 58 | 30° C. | 86.3 | A+ | 0.38 | A+ | 1950 | A+ |
| Ex. 59 | 40° C. | 86.4 | A+ | 0.37 | A+ | 1960 | A+ |
| Ex. 60 | 60° C. | 86.8 | A+ | 0.31 | A+ | 1960 | A+ |
| Ex. 61 | 80° C. | 87.2 | A+ | 0.29 | A+ | 1960 | A+ |
| Ex. 62 | 90° C. | 86.7 | A+ | 0.32 | A+ | 1970 | A+ |
| Ex. 63 | 100° C. | 86.0 | A+ | 0.39 | A | 1970 | A+ |
| Ex. 64 | 110° C. | 85.8 | A+ | 0.40 | A+ | 1970 | A+ |

As evident from Table 5, in Examples 33 to 40 in which the positive electrode was washed with the washing fluid containing LiPF₆ and PC, the capacity retention rate of the lithium ion battery was improved, and the amount of battery swelling after charge/discharge cycling was reduced. In Examples 33 to 40, the amount of the attached lithium fluoride in the battery after fabrication was 700 μg or more and 4000 μg or less per 1 g mass of the positive electrode active material.

As evident from Table 6, in Examples 41 to 48 in which the positive electrode was washed with the washing fluid containing LiPF₆, PC, and HF, the capacity retention rate of the lithium ion battery was high, and the amount of battery swelling after charge/discharge cycling was reduced. In Examples 41 to 48, the amount of the attached lithium fluoride in the battery after fabrication was 1100 μg or more and 4000 μg or less per 1 g mass of the positive electrode active material.

As evident from Table 7, in Examples 49 to 56 in which the positive electrode was washed with the washing fluid containing PC and HF, the capacity retention rate of the lithium ion battery was improved, and the amount of battery swelling after charge/discharge cycling was reduced. In Examples 49 to 56, the amount of the attached lithium fluoride in the battery after fabrication was 300 μg or more and 700 μg or less per 1 g mass of the positive electrode active material.

As evident from Table 8, in Examples 57 to 64 in which the positive electrode was washed with the washing fluid containing PC and HF, the capacity retention rate of the lithium ion battery was improved, and the amount of battery swelling after charge/discharge cycling was reduced. In Examples 57 to 64, the amount of the attached lithium fluoride in the battery after fabrication was 1800 μg or more and 3200 μg or less per 1 g mass of the positive electrode active material.

### INDUSTRIAL APPLICABILITY

The present invention is useful in the field of lithium ion batteries such as a lithium ion battery. The present invention is particularly useful in the fields of: for example, power sources for portable electronic devices such as cellular phones, personal digital assistants (PDAs), notebook personal computers, digital cameras, and portable game machines; vehicle-mounted power sources for electric vehicles, hybrid vehicles, and the like; and uninterruptible power supply.

1. A method of producing a positive electrode for a lithium ion battery, the method comprising the step of washing with a washing fluid, a positive electrode having a positive electrode active material layer including a lithium transition metal oxide as a positive electrode active material, to attach a lithium halide on a surface of the positive electrode active material in an amount of 300 to 4000 μg of per 1 g of the positive electrode active material, wherein:
the washing fluid includes an aprotic solvent and a solute; and
the solute includes at least one of a hydrogen halide and a fluorine-containing lithium salt represented by the general formula (1):
LiZF₆₋ₘRₘ₋ₙ,
where Z is at least one of phosphorus, boron, arsenic, and antimony; R is a C1 or C2 perfluoroalkyl group; m is an integer of 0 to 3 when Z is phosphorus, 2 when Z is boron, and 0 when Z is arsenic or antimony; and n is 0 when Z is phosphorus, arsenic, or antimony, and 2 when Z is boron.

2. The method of producing a positive electrode for a lithium ion battery in accordance with claim 1, wherein the fluorine-containing lithium salt represented by the general formula (1) includes at least one selected from the group consisting of LiPF₆, LiBF₄, LiSbF₆, LiAsF₆, LiPF₃(CF₃)₃, LiPF₃(C₂F₅)₃, LiPF₄(CF₃)₂, and LiPF₅CF₃.

3. The method of producing a positive electrode for a lithium ion battery in accordance with claim 2, wherein the fluorine-containing lithium salt represented by the general formula (1) includes LiPF₆.

4. The method of producing a positive electrode for a lithium ion battery in accordance with claim 1, wherein the washing fluid includes the fluorine-containing lithium salt represented by the general formula (1) at a concentration of 0.5 to 1.5 mol/L.

5. The method of producing a positive electrode for a lithium ion battery in accordance with claim 4, wherein the washing fluid further includes the hydrogen halide in a ratio of 2000 ppm by mass or less.

6. The method of producing a positive electrode for a lithium ion battery in accordance with claim 5, wherein the hydrogen halide includes hydrogen fluoride.

7. The method of producing a positive electrode for a lithium ion battery in accordance with claim 1, wherein the washing fluid includes the hydrogen halide in a ratio of 300 to 4000 ppm by mass.

8. The method of producing a positive electrode for a lithium ion battery in accordance with claim 7, wherein the hydrogen halide includes hydrogen fluoride.

9. The method of producing a positive electrode for a lithium ion battery in accordance with claim 1, wherein the aprotic solvent includes propylene carbonate.

10. The method of producing a positive electrode for a lithium ion battery in accordance with claim 9, wherein the content of the propylene carbonate in the aprotic solvent is 50 to 100% by mass.

11. The method of producing a positive electrode for a lithium ion battery in accordance with claim 1, wherein the washing fluid is at a temperature of 40 to 90° C.

12. A positive electrode for a lithium ion battery comprising a positive electrode current collector, and a positive electrode active material layer formed on a surface of the positive electrode current collector, wherein
the positive electrode active material layer includes a lithium transition metal oxide as a positive electrode active material, and
a lithium halide is attached on a surface of the positive electrode active material in an amount of 300 to 4000 μg per 1 g of the positive electrode active material.

13. The positive electrode for a lithium ion battery in accordance with claim 12, wherein the lithium halide includes lithium fluoride.

14. The positive electrode for a lithium ion battery in accordance with claim 12, wherein the lithium transition metal oxide includes a lithium nickel oxide.

15. The positive electrode for a lithium ion battery in accordance with claim 14, wherein the lithium transition metal oxide is represented by the general formula (2):
LiₓNi_{w}M_{z}Me_{1-(w+z)}O_{2+d},
where M is at least one element selected from cobalt and manganese; Me is at least one element selected from the group consisting of metal elements other than M, boron, phosphorus, and sulfur; d represents oxygen deficiency or oxygen surplus; 0.98≦x≦1; 0.3≦w≦1; 0≦z≦0.7; and 0.9≦(w+z)≦1.

16. A lithium ion battery comprising the positive electrode for a lithium ion battery of claim 12, a negative electrode, a separator interposed between the positive electrode and the negative electrode, and a non-aqueous electrolyte.
